(19) United States
(12) Patent Application Publication
(10) Pub. No.: US 2022/0362098 A1
(43) Pub. Date: Nov. 17, 2022

(54) HUMAN BODY STIMULATION DEVICE AND HUMAN BODY STIMULATION METHOD USING HUMAN BODY STIMULATION DEVICE

(71) Applicant: HUTECH INDUSTRY CO., LTD., Cheonan-si (KR)

(72) Inventors: Hwa Don JU, Gimpo-si (KR); Sung Don KWON, Gimpo-si (KR)

(21) Appl. No.: 17/816,705

(22) Filed: Aug. 1, 2022

Related U.S. Application Data
(63) Continuation of application No. PCT/KR2022/001212, filed on Jan. 24, 2022.

(30) Foreign Application Priority Data
Feb. 2, 2021 (KR) 10-2021-0014993

(51) Int. Cl. A61H 23/00; A61H 7/00; A61H 15/00; A61H 39/00

(52) U.S. Cl. CPC A61H 23/008; A61H 23/006; A61H 7/007; A61H 15/0078; A61H 39/007; A61H 2201/5064; A61H 2201/1207; A61H 2201/5005; A61H 2015/0042; A61H 2015/0071

(57) ABSTRACT

A human body stimulation device and a human body stimulation method using the human body stimulation device. A human body stimulation device includes a human body stimulation unit including a sonic vibration module configured to apply sonic vibration to a body of the user, at least one motor configured to move the sonic vibration module, a position detection unit configured to detect a position of the sonic vibration module, and a controller. The controller determines a body part corresponding to the detected position of the sonic vibration module and controls the sonic vibration module to output the sonic vibration based on characteristics of the body part.

### CROSS-REFERENCE TO RELATED APPLICATIONS

This is a bypass continuation application of International PCT application No. PCT/KR2022/001212 filed on Jan. 24, 2022, which claims priority to Republic of Korea patent application no. 10-2021-0014993, filed on Feb. 2, 2021, which are incorporated by reference in their entirety.

### TECHNICAL FIELD

The present invention relates to a human body stimulation device and a human body stimulation method using the human body stimulation device, and more particularly, to a human body stimulation device for providing a sonic vibration massage, and a human body stimulation method using the human body stimulation device.

### BACKGROUND ART

As the quality of life is improved, an interest in massages that assist in relieving fatigue and stress is increasing. Recently, among the massages, due to a soft massage feeling, a demand for a sonic vibration massage, which transmits sonic vibrations to a body part to carefully massage the body part, is increasing.

Thus, there is a massage device to which the conventional device for generating sonic vibration is applied, but such a massage device simply transmits sonic vibration to a body part of a user and does not provide sonic vibration optimized for each body part of the user, and thus there is a problem in that an effective massage is not performed.

Therefore, there is a need to develop a technology for providing a sonic vibration massage optimized for each body part of a user.

### SUMMARY

The present invention is directed to providing a human body stimulation device for transmitting optimal sonic vibration for each body part of a user, and a human body stimulation method using the human body stimulation device.

The present invention is directed to providing a human body stimulation device for providing general massages such as a tapping massage and a kneading massage along with a sonic vibration massage to a body part of a user, and a human body stimulation method using the human body stimulation device.

Technical solutions of the present specification may not be limited to the above, and other technical solutions which are not described herein should be clearly understood by those skilled in the art, to which the present invention belongs, from the present specification and the accompanying drawings.

According to one embodiment of the present invention, a human body stimulation device for providing a sonic vibration massage in response to a body part of a user includes a human body stimulation unit including a sonic vibration module configured to apply sonic vibration to a body of the user, a driving unit including at least one motor configured to move the sonic vibration module, a position detection unit configured to detect a position of the sonic vibration module, and a controller, wherein the controller determines a body part corresponding to the detected position of the sonic vibration module and controls the sonic vibration module to output the sonic vibration based on characteristics of the body part, when the sonic vibration module is positioned at a first body part requiring the sonic vibration massage through sonic vibration having a first property, the sonic vibration module outputs the sonic vibration having the first property, when the sonic vibration module is positioned at a second body part requiring the sonic vibration massage through sonic vibration having a second property that is different from the first property, the sonic vibration module outputs the sonic vibration having the second property, and the first property and the second property of the sonic vibration include at least one of a frequency, an amplitude, and a waveform of the sonic vibration.

According to one embodiment of the present invention, a human body stimulation method of providing a sonic vibration massage in response to a body part of a user includes detecting a position of a human body stimulation unit including a sonic vibration module, determining a body part corresponding to the detected position of the human body stimulation unit, and controlling the sonic vibration module to output sonic vibration based on characteristics of the body part, wherein, when the sonic vibration module is positioned at a first body part requiring the sonic vibration massage through sonic vibration having a first property, the sonic vibration module outputs the sonic vibration having the first property, when the sonic vibration module is positioned at a second body part requiring the sonic vibration massage through sonic vibration having a second property that is different from the first property, the sonic vibration module outputs the sonic vibration having the second property, and the first property and the second property of the sonic vibration include at least one of a frequency, an amplitude, and a waveform of the sonic vibration.

The objects of the present invention are not limited to the above-described objects, and other objects which are not described herein should be clearly understood by those skilled in the art, to which the present invention belongs, from the following detailed description and the accompanying drawings.

According to one embodiment of the present application, optimal sonic vibration is transmitted for each body part of a user, thereby effectively providing a sonic vibration massage.

According to one embodiment of the present application, general massages such as a tapping massage and a kneading massage are provided along with a sonic vibration massage to a body part of a user, thereby providing various massages to the user.

Effects of the present application may not be limited to the above, and other effects which are not described herein should be clearly understood by those skilled in the art, to which the present invention belongs, from the present specification and the accompanying drawings.

### BRIEF DESCRIPTION OF DRAWINGS

FIG. 1 is a view illustrating a human body stimulation device according to one embodiment.

FIG. 2 is a front view of a human body stimulation unit according to one embodiment.

FIG. 3 is a side view of the human body stimulation unit according to one embodiment.

FIG. 4 is a view illustrating a human body stimulation unit according to another embodiment.

FIG. 5 is a flowchart of a method of providing a massage according to one embodiment.

FIG. 6 is a flowchart of a method of providing a vibration massage for each position of a sonic vibration module according to one embodiment.

FIG. 7 is a flowchart of a method of providing a massage according to another embodiment.

FIG. 8 is a flowchart of a method of determining a body part according to one embodiment.

FIG. 9 is a diagram related to determination of a body part according to one embodiment.

FIG. 10 is a diagram related to determination of a body part according to another embodiment.

FIG. 11 is a flowchart of a method of providing a vibration massage for each body part according to one embodiment.

FIG. 12 is a diagram illustrating an example of optimal vibration for each body part according to one embodiment.

FIG. 13 is a flowchart of a method of providing a vibration massage in consideration of an acupoint according to one embodiment.

FIG. 14 is a flowchart of a method of providing a multi-massage according to one embodiment.

FIGS. 15 and 16 are diagrams for describing the provision of a multi-massage according to one embodiment.

FIGS. 17 and 18 are views illustrating a human body stimulation device including sonic vibration modules installed at different positions according to one embodiment.

FIG. 19 is a flowchart of a method of providing a sonic vibration massage in which sonic vibration modules installed at different positions are interlocked with each other according to one embodiment.

FIG. 20 shows examples of the provision of a sonic vibration massage in which sonic vibration modules installed at different positions are interlocked with each other according to one embodiment.

### DETAILED DESCRIPTION

Embodiments described in the present specification are made to clearly explain the scope of the present invention to those having ordinary skill in the art and are not intended to limit the present invention. It should be interpreted that the present invention may include substitutions and modifications within the technical scope of the present invention.

The terms used in the present specification are selected from general terms, which are widely used currently, based on functions of components according to the embodiment of the present invention, and may have meanings varying according to the intentions of those skilled in the art, the custom in the field of art or advent of new technology. If a specific term is used with a specific meaning, the meaning of the term will be described specifically. Accordingly, the terms used in the present specification should not be defined as simple names of the components but should be defined based on the actual meaning of the terms and the whole context throughout the present specification.

The accompanying drawings are to facilitate the explanation of the present invention and the shape in the drawings may be exaggerated for the purpose of convenience of explanation, so the present invention should not be limited to the drawings.

In addition, the details of the generally known function and structure, which make the subject matter of the present invention unclear, will be omitted.

According to one aspect of the present application, there may be provided a human body stimulation device for providing a sonic vibration massage in response to a body part of a user, the human body stimulation device including a human body stimulation unit including a sonic vibration module configured to apply sonic vibration to a body of the user, a driving unit including at least one motor configured to move the sonic vibration module, a position detection unit configured to detect a position of the sonic vibration module, and a controller, wherein the controller determines a body part corresponding to the detected position of the sonic vibration module and controls the sonic vibration module to output the sonic vibration based on characteristics of the body part, when the sonic vibration module is positioned at a first body part requiring the sonic vibration massage through sonic vibration having a first property, the sonic vibration module outputs the sonic vibration having the first property, when the sonic vibration module is positioned at a second body part requiring the sonic vibration massage through sonic vibration having a second property that is different from the first property, the sonic vibration module outputs the sonic vibration having the second property, and the first property and the second property of the sonic vibration include at least one of a frequency, an amplitude, and a waveform of the sonic vibration.

According to one embodiment, the characteristics of the body part may be related to a content of at least one of a bone, a fat, and a muscle.

According to one embodiment, the first body part may have the content of the bone that is higher than that of the second body part, the sonic vibration having the first property may be sonic vibration having a high frequency, and the sonic vibration having the second property may be sonic vibration having a low frequency.

According to one embodiment, the first body part may have the content of the fat and/or muscle that is lower than that of the second body part, the sonic vibration having the first property may be sonic vibration having a high frequency, and the sonic vibration having the second property may be sonic vibration having a low frequency.

According to one embodiment, the first body part may have the content of the bone that is higher than that of the second body part, the sonic vibration having the first property may be sonic vibration having a low amplitude, and the sonic vibration having the second property may be sonic vibration having a high amplitude.

According to one embodiment, the first body part may have the content of the fat and/or muscle that is lower than that of the second body part, the sonic vibration having the first property may be sonic vibration having a low amplitude, and the sonic vibration having the second property may be sonic vibration having a high amplitude.

According to one embodiment, the human body stimulation unit may provide a motion massage including a tapping massage and/or a kneading massage along with the sonic vibration massage to the body part, and the human body stimulation unit may provide the sonic vibration massage in consideration of movement of the sonic vibration module according to the motion massage.

According to one embodiment, the human body stimulation unit may provide the motion massage such that the sonic vibration module moves only within the first body part or the second body part, and the sonic vibration module may output sonic vibration having a property corresponding to the body part to which the motion massage is provided.

According to one embodiment, the human body stimulation unit may provide the motion massage such that the sonic vibration module moves between the first body part and the second body part, and the sonic vibration module may output the sonic vibration having the first property when the sonic vibration module is positioned at the first body part due to the motion massage and may output the sonic vibration having the second property when the sonic vibration module is positioned at the second body part due to the motion massage.

According to one embodiment, the human body stimulation unit may provide the motion massage such that the sonic vibration module moves between the first body part and the second body part, and the sonic vibration module may output sonic vibration having a third property representing the first property and the second property.

According to one embodiment, the human body stimulation device may further include a massage ball that moves in conjunction with the sonic vibration module, and the human body stimulation unit may provide a motion massage including a tapping massage and/or a kneading massage in consideration of a position of the massage.

According to one embodiment, the body part may have an acupoint, and the sonic vibration module may output sonic vibration, having a different property from that of the sonic vibration output to the body part, at a position corresponding to the acupoint.

According to one embodiment, the position detection unit may include at least one sensor configured to detect at least one of a vertical position and a horizontal position of the human body stimulation unit.

According to one embodiment, the human body stimulation device may further include an additional human body stimulation unit which is disposed at a different position from the human body stimulation unit and includes an additional sonic vibration module, and the controller may control the sonic vibration module in conjunction with the additional sonic vibration module.

According to one embodiment, the controller may control at least one of a vibration start time, a vibration duration time, a frequency, an amplitude, and a waveform of sonic vibration output from the sonic vibration module to be synchronized with at least one of a vibration start time, a vibration duration time, a frequency, an amplitude, and a waveform of sonic vibration output from the additional sonic vibration module.

According to one embodiment, the human body stimulation device may be chair-type, sofa-type, or bed-type human body stimulation device.

According to one aspect of the present application, there may be provided a human body stimulation method of providing a sonic vibration massage in response to a body part of a user, the human body stimulation method including detecting a position of a human body stimulation unit including a sonic vibration module, determining a body part corresponding to the detected position of the human body stimulation unit, and controlling the sonic vibration module to output sonic vibration based on characteristics of the body part, wherein, when the sonic vibration module is positioned at a first body part requiring the sonic vibration massage through sonic vibration having a first property, the sonic vibration module may output the sonic vibration having the first property, when the sonic vibration module is positioned at a second body part requiring the sonic vibration massage through sonic vibration having a second property that is different from the first property, the sonic vibration module may output the sonic vibration having the second property, and the first property and the second property of the sonic vibration may include at least one of a frequency, an amplitude, and a waveform of the sonic vibration.

Hereinafter, a human body stimulation device may refer to various types of devices for providing a function of providing stimulation to a user. There may be various purposes of providing stimulation to the user. For example, the human body stimulation device may provide stimulation to the user for various purposes such as a massage purpose, a medical purpose, a pain relief purpose, a fatigue recovery purpose, a rehabilitation purpose, a health improvement purpose, and a weight training purpose. In addition, according to the purpose, the human body stimulation device may include various devices such as a massage device, a medical device, a pain relief device, a fatigue recovery device, a rehabilitation device, a health improvement device, and a weight training device.

In the present specification, for convenience of description, the present invention and various embodiments will be described based on the massage device among various human body stimulation devices. However, the present invention is not limited to the massage device, and of course, descriptions of the present invention may be applied to the various human body stimulation devices other than the massage device.

Hereinafter, a human body stimulation operation may refer to an operation of providing stimulation to the user. As described above, as a purpose of stimulating the user, there are various purposes such as a massage purpose, a medical purpose, a pain relief purpose, a fatigue recovery purpose, a rehabilitation purpose, a health improvement purpose, and a weight training purpose. In addition, according to the purpose, the human body stimulation operation may also include various operations such as a massage operation, a medical operation, a pain relief operation, a fatigue recovery operation, a rehabilitation operation, a health improvement operation, and a weight training operation.

In the present specification, for convenience of description, the present invention and various embodiments will be described based on the massage operation among various human body stimulation operations. However, the present invention is not limited to the massage operation, and of course, descriptions of the present invention may be applied to the various human body stimulation operations other than the massage operation.

Hereinafter, the massage operation may refer to an operation of providing stimulation to the user in order to facilitate body metabolism. In one embodiment, the massage operation may include a motion massage, a vibration massage (motor vibration massage or sonic vibration massage), an air massage, a thermal massage, and a multimodal massage. In addition, the motion massage, the vibration massage (motor vibration massage or sonic vibration massage), the air massage, the thermal massage, and the multimodal massage may be expressed as a motion stimulation operation, a vibration stimulation operation (motor vibration stimulation operation or sonic vibration stimulation operation), an air stimulation operation, a thermal stimulation operation, and a multimodal stimulation operation.

In addition, as described above, for convenience of description, the present invention will be described based on a massage, and the description of the present invention is not limited to a massage device and a massage operation. For example, in the present specification, of course, a massage device, a massage unit, and a massage member may be expressed as a stimulation device, a stimulation unit, and a stimulation member.

In addition, as described above, for convenience of description, the present invention will be described based on a massage, and the description of the present invention is not limited to a massage device and a massage operation. For example, in the present specification, of course, the motion massage member, the vibration massage member (motor vibration massage member or sonic vibration massage member), the air massage member, and the thermal massage member may be expressed as a motion stimulation member, a vibration stimulation member (motor vibration stimulation member or sonic vibration massage member), air stimulation member, and a thermal stimulation member.

In the present specification, the expression “motion massage” may refer to a generally performed massage and may refer to an act of stimulating a body part such as repeatedly pressing the body part for a certain time or more or shaking the body part. For example, the motion massage may include various massages such as a massage for tapping a body, a massage for kneading the body, and a massage for sweeping the body in a specific direction. The motion massage should be broadly interpreted as including not only a conventional massage such as a tapping massage or a kneading massage but also a massage in which an applicator for massaging a body part moves and stimulates a body part.

In the present specification, the expression “vibration massage” may refer to a massage that applies vibration to a body part and may refer to an act of stimulating the body part through vibration. For example, the vibration massage may include a massage for transmitting vibration generated by a vibrator or a motor to a body part, a sonic vibration massage, and the like. The vibration massage should be broadly interpreted as including not only a sonic vibration massage but also a massage that provides vibration stimulation to a body part through an applicator for massaging a body part.

Sonic vibration may be a type of vibration and may refer to vibration generated based on the generation of sound waves. For example, sonic vibration may be generated due to vibration of air generated when a sound source is input to a device for outputting sonic vibration.

A sonic vibration massage means that sonic vibration is transmitted to a body of a user to obtain a massage effect. When an appropriate sonic vibration massage is performed on the user, the user may obtain effects of improving health, such as effects of lessening a fatigue feeling, improving blood circulation, and relieving stress. The sonic vibration massage may cause various effects during a massage as compared with other vibration massages. For example, since, in the sonic vibration massage, a repulsive force from skin is small during a massage, the sonic vibration massage may provide a good massage feeling to the user and may reduce body fatigue, which may be caused by vibration stimulation, as compared with other vibration massages. In addition, according to the sonic vibration massage, when sonic vibration is applied to skin in a direction perpendicular to a body part, penetration of the sonic vibration, which is applied to the body part, into a muscle may be further improved.

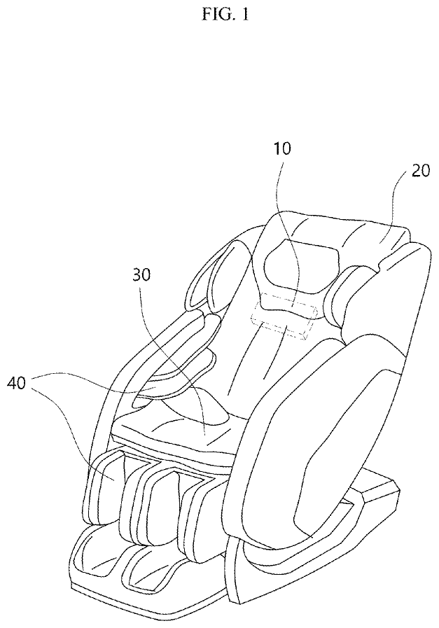

FIG. 1 is a view illustrating a human body stimulation device 1 according to one embodiment.

Referring to FIG. 1, the human body stimulation device 1 according to one embodiment may be implemented as a chair-type human body stimulation device 1. For example, the human body stimulation device 1 may be a massage chair including a backrest 20, a seat 30, and an arm/leg unit 40. However, the present invention is not limited thereto, and the human body stimulation device 1 may be implemented as other types such as a bed type and a sofa type other than a chair type. For example, the human body stimulation device 1 according to one embodiment may be a bed-type device in which a human body stimulation unit 10 is provided in a mattress.

The human body stimulation device 1 according to one embodiment may include massage members for massaging a body of a user. For example, the human body stimulation device 1 may include massage members such as air cells, rollers, and acupressure protrusions in the backrest 20, the seat 30, and/or the arm/leg unit 40.

The human body stimulation device 1 according to one embodiment may massage the body of the user through the human body stimulation unit 10. For example, the human body stimulation device 1 may massage the body of the user through the human body stimulation unit 10 installed inside the backrest 20. For example, the human body stimulation unit 10 may provide various stimuli for a body massage to a body, such as tapping, kneading, and pressing the body. Specifically, the human body stimulation unit 10 may drive an arm 200 through a driving unit 100 to physically massage a body through a massage ball 400 or a sonic vibration module 300 disposed at one end portion of the arm 200.

In addition, the human body stimulation unit 10 may have a function of providing a sonic vibration massage on a body. The sonic vibration massage means that sonic vibration is transmitted to the body of the user to obtain a massage effect. When an appropriate sonic vibration massage is performed on the user, the user may obtain effects of improving health, such as effects of lessening a fatigue feeling, improving blood circulation, and relieving stress. For example, the human body stimulation unit 10 may perform a sonic vibration massage by transmitting sonic vibration to the body of the user through the sonic vibration module 300 disposed at one end portion of the arm 200. Here, the human body stimulation unit 10 may perform a sonic vibration massage on a body and simultaneously drive the arm 200 through the driving unit 100 to physically massage the body through the sonic vibration module 300 disposed at one end portion of the arm 200.

The human body stimulation unit 10 may be movable to massage a body at a various positions. For example, the human body stimulation unit 10 may include the driving unit 100 to move along the backrest 20 of the human body stimulation device 1 and massage a back of the user at various positions.

The human body stimulation device 1 may include a controller 600 (not shown) which controls each component of the human body stimulation device 1 or processes and calculates various types of information. For example, the controller 600 may control the human body stimulation unit 10 to provide a massage.

The controller 600 may be provided in the form of an electronic circuit which physically processes an electrical signal. The controller 600 may be a concept physically including a plurality of controller 600 as well as a single controller 600. For example, the controller 600 may be provided as one or more processors mounted on one computing device.

Examples of the controller 600 may include a central processing unit (CPU), a graphics processing unit (GPU), a digital signal processor (DSP), a state machine, an application specific integrated circuit (ASIC), a radio-frequency integrated circuit (RFIC), and a combination thereof.

However, the human body stimulation device 1 shown in FIG. 1 is merely an example for convenience of description, and the present invention is not limited thereto. For example, the human body stimulation unit 10 may be installed at any one of other positions, such as the seat 30 and the arm/leg unit 40 instead of the backrest 20. According to some embodiments, components may be added to or excluded from the human body stimulation device 1 of FIG. 1 and may also be subdivided. For example, the human body stimulation device 1 according to one embodiment may further include an operation unit which receives a user input, a display unit which displays a picture or an image, and a speaker which outputs sound.

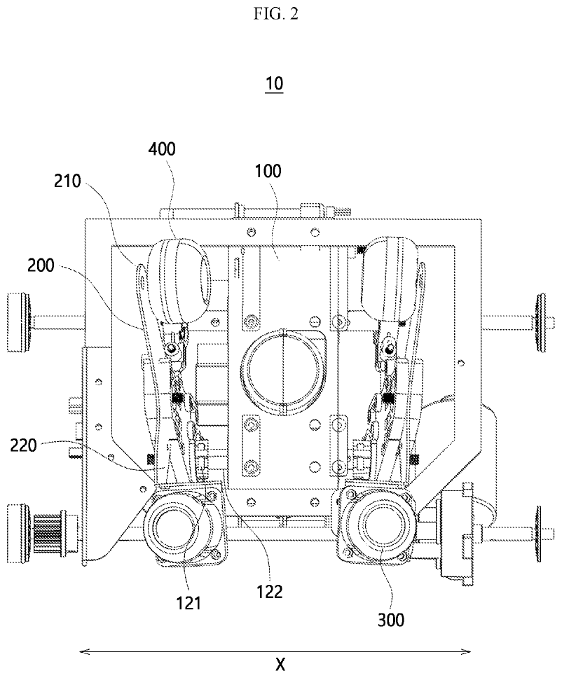

Hereinafter, a human body stimulation unit 10 according to one embodiment will be described with reference to FIGS. 2 to 4.

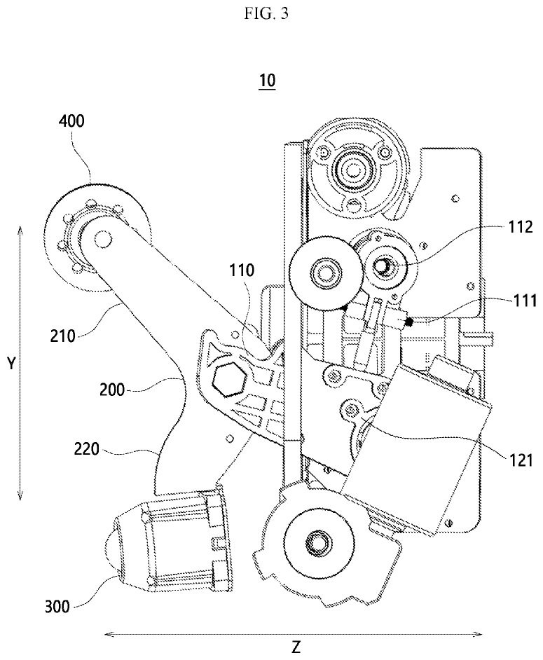

FIG. 2 is a front view of the human body stimulation unit 10 according to one embodiment, and FIG. 3 is a side view of the human body stimulation unit 10 according to one embodiment.

Referring to FIGS. 2 and 3, the human body stimulation unit 10 according to one embodiment may include a driving unit 100, an arm 200, a sonic vibration module 300, a massage ball 400, and a position detection unit 500 (not shown).

The driving unit 100 may be configured to move the human body stimulation unit 10 itself. For example, the driving unit 100 may move the human body stimulation unit 10 upward or downward along a guide rail (not shown) installed in a backrest 20. Specifically, the driving unit 100 may allow teeth to be engaged with the guide rail so as to be movable along the guide rail and may rotate the teeth using a lifting motor (not shown) to move the teeth along the guide rail.

The driving unit 100 may be configured to move the components of the human body stimulation unit 10. For example, the driving unit 100 may move the arm 200 in various directions to tap, knead, or press a body. Here, the sonic vibration module 300 and/or the massage ball 400 may be connected to one end portion of the arm 200, may come into contact with a body of a user according to the movement of the arm 200, and may tap or knead the body.

The driving unit 100 may provide a tapping massage to a body by moving the arm 200.

For example, for the tapping massage, the driving unit 100 may include a holder 110 for mounting the arm 200, a link for receiving power from a rotating body 111 to move the holder 110 in a certain route range, and a tapping motor 112 for rotating the rotating body 111. Specifically, the tapping motor 112 may rotate the rotating body 111, a force according to the rotation of the rotating body 111 may be transmitted to the link, and the link may move one end of the connected holder 110 within a certain motion route to move the arm 200. Finally, the sonic vibration module 300 and the massage ball 400 may move the arm 200 forward or backward in a Z-axis direction, may move at a certain motion angle, and may come into contact with a body to tap the body. Here, when a speed of the rotating body 111 increases, a speed of tapping the body may also increase.

The driving unit 100 may provide a kneading massage to a body by moving the arm 200.

For example, for the kneading massage, the driving unit 100 may include a kneading motor 120 (not shown), an eccentric rotating body 121, and a support shaft 122. Specifically, as the kneading motor 120 is driven, the eccentric rotating body 121 installed on the support shaft 122 may rotate eccentrically to move the arm 200 such that the sonic vibration module 300 and the massage ball 400 perform a kneading operation. Here, due to the eccentric rotation of the eccentric rotating body 121, the kneading operation may include all of movement in upward/downward movement in a Y-axis direction, forward/backward movement in the Z-axis direction, and leftward/rightward movement in an X-axis direction so that a route draws a circular motion or an elliptical motion. Accordingly, a contact angle of the massage ball 400 and/or the sonic vibration module 300 in contact with a body may also be changed.

Of course, the driving unit 100 is not limited to the above description and may be driven in other ways.

The arm 200 may include an upper portion 210 and a lower portion 220 which move in conjunction with each other. For example, as the upper portion 210 approaches the body of the user, the lower portion 220 may also approach the body of the user.

The arm 200 may be connected to the massage ball 400 and/or the sonic vibration module 300. For example, the massage ball 400 may be installed at the upper portion 210 of the arm 200, and the sonic vibration module 300 may be installed at the lower portion 220 of the arm 200. Here, the upper portion 210 of the arm 200 connected to the massage ball 400 may be configured to provide a massage such as tapping or kneading to the body of the user through the massage ball 400, and the lower portion 220 of the arm 200 connected to the sonic vibration module 300 may be configured to provide a sonic vibration massage to the body of the user through the sonic vibration module 300.

Of course, the arm 200 is not limited to the above description. The arm 200 may be connected to the massage ball 400 and/or the sonic vibration module 300 in another form in which the upper portion 210 of the arm 200 is connected to the sonic vibration module 300, and the lower portion 220 of the arm 200 is connected to the massage ball 400.

The sonic vibration module 300 may be an applicator for performing a sonic vibration massage function. For example, the sonic vibration module 300 may generate sonic vibration and may be in direct/indirect contact with a body to transmit the generated sonic vibration to the body.

Sonic vibration used for a sonic vibration massage may be sonic vibration in an audible frequency range. For example, the sonic vibration used for the sonic vibration massage may have a frequency range of 10 Hz to 300 Hz.

In addition, the sonic vibration module 300 may output sonic vibrations having various properties. For example, the properties of sonic vibration may include at least one of a frequency, an amplitude, and a waveform of the sonic vibration. Here, a waveform may be related to a degree in which the sonic vibration is changed for a reference time unit and may refer to, for example, a change pattern of at least one of a frequency and an amplitude. As an example, the waveform may include a sinusoidal waveform, a triangular waveform, and the like.

The properties of the sonic vibration may be related to an intensity and a massaging feeling of a sonic vibration massage.

For example, when sonic vibration having a low frequency is output from the sonic vibration module 300, an intensity of the output sonic vibration may be strong. That is, a sonic vibration massage having a higher intensity may be provided to the user using sonic vibration having a low frequency.

For another example, when sonic vibration having a high frequency is output from the sonic vibration module 300, an intensity of the output sonic vibration may be weak. That is, a soft sonic vibration massage having a lower intensity may be provided to the user using sonic vibration having a high frequency.

For example, when sonic vibration having a high amplitude is output from the sonic vibration module 300, an intensity of the output sonic vibration may be strong. That is, a sonic vibration massage having a higher intensity may be provided to the user using sonic vibration having a high amplitude.

For another example, when sonic vibration having a low amplitude is output from the sonic vibration module 300, an intensity of the output sonic vibration may be weak. That is, a soft sonic vibration massage having a lower intensity may be provided to the user using sonic vibration having a low amplitude.

For example, when sonic vibration having a gradually changing waveform is output from the sonic vibration module 300, a massage feeling of the output sonic vibration may be soft. That is, a sonic vibration massage with a softer massage feeling may be provided to the user using sonic vibration having a gradually changing waveform.

For another example, when rapidly changing sonic vibration is output from the sonic vibration module 300, a massage feeling of the output sonic vibration may be strong. That is, a sonic vibration massage with a stronger massage feeling may be provided to the user using sonic vibration having a rapidly changing waveform.

Of course, the properties of sonic vibration are not limited to the above description, and other properties such as a volume of an input sound source are also acceptable.

The sonic vibration module 300 may be an applicator for performing a general massage function. For example, the sonic vibration module 300 may be connected to arm 200 and may perform a general massage such as a tapping or kneading massage on the body of the user in synchronization with movement of the arm 200. To this end, the sonic vibration module 300 may include a sonic vibration generator 310, a head 320, and a housing 330. The sonic vibration module 300 may generate sonic vibration through the sonic vibration generator 310 and may transmit the generated sonic vibration to the body of the user through the head 320 connected to the sonic vibration unit.

The sonic vibration generator 310 may generate sonic vibration. For example, the sonic vibration generator 310 may include devices (not shown) for reproducing a sound source therein, for example, a codec, an amplifier, and a speaker, and may generate vibration using a sound source. Here, the sonic vibration generator 310 may output sonic vibration corresponding to a sound source.

The head 320 may transmit the generated sonic vibration to the body of the user. For example, the head 320 may be connected to the sonic vibration generator 310 and may transmit the sonic vibration transmitted from the sonic vibration generator 310 to the body of the user in direct/indirect contact therewith. Here, the head 320 may be made of various materials, for example, a silicone material, a wood material, a plastic material, and a metal material. The head 320 may transmit stronger sonic vibration to the user by locally transmitting the sonic vibration to the body of user.

The head 320 may be implemented in various shapes. For example, one end of the head 320 in contact with a body may be provided to have a round curved surface including a spherical shape, a hemispherical shape, or a streamlined shape.

The housing 330 may accommodate the sonic vibration generator 310. For example, the housing 330 may surround the sonic vibration generator 310 therein and may prevent an external force due to a massage from being applied to the sonic vibration generator 310. Thus, the durability of the sonic vibration module 300 can be improved.

The housing 330 may at least partially accommodate the head 320. For example, the housing 330 may surround a portion of the head 320 connected to the sonic vibration generator 310 and may expose a portion of the head 320 through a pierced hole such that the head 320 may be in direct/indirect contact with the body of the user. Since the housing 330 exposes only a portion of the head 320, the housing 330 may prevent the head from being tilted and damaged due to an external force applied from a side surface of the head 320.

The housing 330 may be implemented in various shapes. For example, a portion of the housing 330 in contact with a body may be provided as a round surface to be in smooth contact with the body. Here, a hole through which the head 320 passes may be formed in the housing 330 such that a portion of the head 320 may be exposed to the outside. Specifically, in order to prevent the head 320 from being heavily tilted due to an external force, a buffer member made of a silicone material or the like may be provided in a space between the head 320 and the hole of the housing 330.

Of course, the sonic vibration module 300 is not limited to the above description, and for example, the sonic vibration module 300 may be implemented in other forms for transmitting sonic vibration to a body without the head 320.

The massage ball 400 may be an applicator for performing a general massage function. For example, the massage ball 400 may be connected to the arm 200 and may perform a general massage such as a tapping or kneading massage on the body of the user in synchronization with the movement of the arm 200.

The massage ball 400 may have a shape, material, or the like for performing a massage. For example, the massage ball 400 may have a curved shape and may have an elliptical shape or a spherical shape in a plan view. For another example, the massage ball 400 may be made of an elastic material such as rubber or silicone for a soft massage.

The position detection unit 500 may detect a position of the human body stimulation unit 10 itself or components thereof. For example, the position detection unit 500 may identify the position of the human body stimulation unit 10 using a position detection sensor provided in a preset area of the human body stimulation device 1. Here, the position detection sensor may include at least one sensor for detecting at least one of a vertical position and a horizontal position of the human body stimulation unit 10.

The position detection unit 500 may include, for example, an encoder, a magnetic sensor, an optical sensor, a pressure sensor, and the like. For example, the position detection unit 500 may include the encoder and may calculate the position of the human body stimulation unit 10 using a rotation value of a motor included in the driving unit 100. For another example, the position detection unit 500 may include the optical sensor and may calculate the position of the human body stimulation unit 10 by identifying the arm 200 that is moved by the driving unit 100 as the sonic vibration module 300 and/or the massage ball 400 come into contact with a body.

Such a position detection unit 500 may detect the position of the human body stimulation unit 10 and may calculate a position of the sonic vibration module 300 based on the detected position of the human body stimulation unit 10.

The position detection unit 500 may identify a body position of the user. For example, the position detection unit 500 may identify a shoulder position of the user. Here, in order to provide an optimal massage for each of users having different body types, the position detection unit 500 may detect a shoulder position of the user and may distinguish a body part of the user using the identified shoulder position.

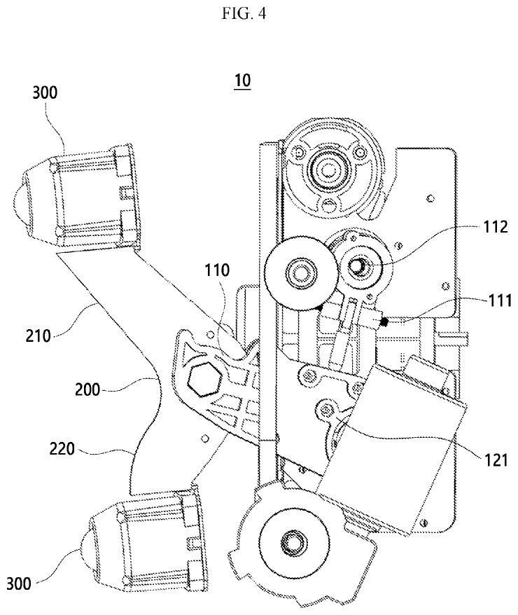

Of course, the human body stimulation unit 10 is not limited to that described above with reference to FIG. 3 and may be implemented in other forms. As an example, the human body stimulation unit 10 may be implemented as shown in FIG. 4. FIG. 4 is a view illustrating a human body stimulation unit 10 according to another embodiment. Referring to FIG. 4, the human body stimulation unit 10 according to one embodiment may include a sonic vibration module 300 instead of a massage ball 400. Here, the human body stimulation unit 10 may provide a general massage as well as a sonic vibration massage to a user using only the sonic vibration module 300.

For another example, the human body stimulation unit 10 may be a different form in which the sonic vibration module 300 of the human body stimulation unit 10 is not mounted on the arm 200 but is mounted on a base of the human body stimulation unit 10. As another example, the sonic vibration module 300 may be installed inside an airbag installed in the human body stimulation unit 10.

According to some embodiments, components may be added to or excluded from the human body stimulation unit 10 of FIGS. 2 to 4 and may also be subdivided.

As an example, the human body stimulation unit 10 may include an X-axis motor for allowing an applicator for a massage to reciprocate in an X-axis direction, a Y-axis motor for allowing the applicator to reciprocate in a Y-axis direction, and a Z-axis motor for allowing the applicator to reciprocate in a Z-axis direction. Here, the human body stimulation unit 10 may provide a tapping massage and/or a kneading massage by combining reciprocating motions in the X-axis, Y-axis, and Z-axis directions.

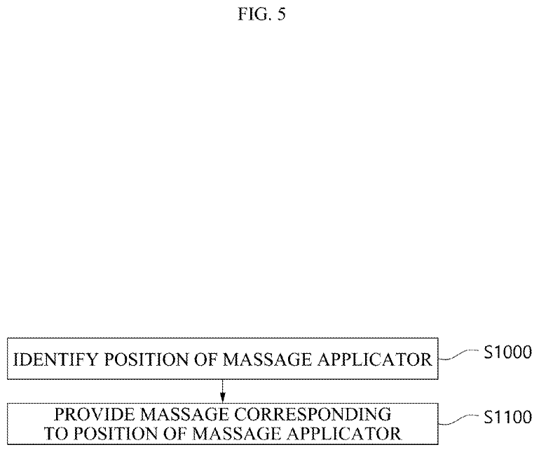

FIG. 5 is a flowchart of a method of providing a massage according to one embodiment. Referring to FIG. 5, the method of providing a massage according to one embodiment may include identifying a position of a massage applicator and providing a massage corresponding to the position of the massage applicator. Here, the massage applicator be interpreted as meaning a human body stimulation applicator and may include various massage applicators such as a human body stimulation unit 10, a sonic vibration module 300, a massage ball 400, and an airbag.

A human body stimulation device 1 may identify a position of the massage applicator (S1000).

A position detection unit 500 may identify the position of the human body stimulation unit 10 itself or components thereof. For example, the position detection unit 500 may know a position of the sonic vibration module 300 through an encoder, a magnetic sensor, an optical sensor, a pressure sensor, or the like provided in a preset area of an arm 200 or the human body stimulation unit 10.

For another example, a controller 600 may identify the position of the massage applicator from a memory (not shown) in which position information of the massage applicator installed at a preset position is stored. Here, the massage applicator may be provided in a form which is fixedly installed in the human body stimulation device 1 to have a fixed position.

The human body stimulation device 1 may provide the massage corresponding to the position of the massage applicator (S1100).

The controller 600 may provide a massage through the human body stimulation unit 10 for each position of the human body stimulation unit 10 based on the identified position of the human body stimulation unit 10. For example, the controller 600 may provide a first massage through the human body stimulation unit 10 at a first position of the human body stimulation unit 10 and may provide a second massage different from the first massage through the human body stimulation unit 10 at a second position of the human body stimulation unit 10 different from the first position. Here, in the massage provided for each position of the massage applicator, types, intensities, and properties of massages, combinations thereof, and the like may be different. As an example, the human body stimulation device 1 may provide a sonic vibration massage or a motion massage according to the position of the massage applicator, and intensities or characteristics of the provided massages may be different.

According to one embodiment, the human body stimulation device 1 may provide a vibration massage corresponding to the position of the massage applicator.

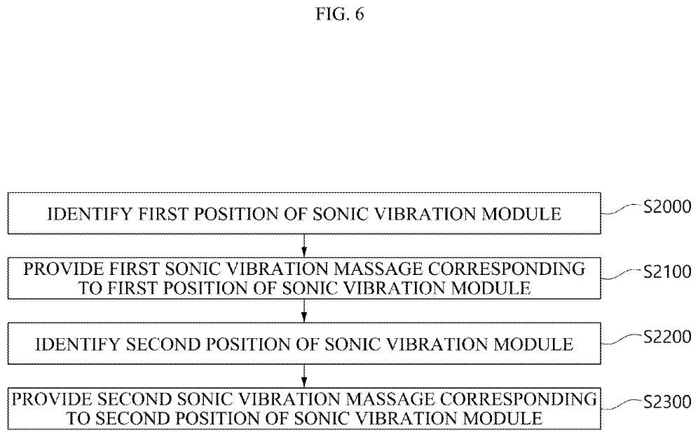

FIG. 6 is a flowchart of a method of providing a vibration massage for each position of a sonic vibration module 300 according to one embodiment. Referring to FIG. 6, the method of providing a vibration massage for each position of the sonic vibration module 300 according to one embodiment may include identifying a first position of the sonic vibration module 300 (S2000), providing a first sonic vibration massage corresponding to the first position (S2100), identifying a second position of the sonic vibration module 300 (S2200), and providing a second sonic vibration massage corresponding to the second position (S2300).

A human body stimulation device 1 may identify the first position of the sonic vibration module 300 (S2000).

A position detection unit 500 may identify the first position of the sonic vibration module 300 moved by a driving unit 100. For example, the position detection unit 500 may know a position of the sonic vibration module 300 through an encoder, a magnetic sensor, an optical sensor, a pressure sensor, or the like provided in a preset area of an arm 200 or a human body stimulation unit 10.

For another example, a controller 600 may identify the first position of the sonic vibration module 300 from a memory (not shown) in which position information of a massage applicator installed at a preset position is stored. Here, the sonic vibration module 300 may be provided in a form in which a plurality of sonic vibration modules 300 are fixedly installed in the human body stimulation device 1 and positioned at different positions.

The human body stimulation device 1 may provide the first sonic vibration massage corresponding to the first position of the sonic vibration module 300 (S2100).

When the sonic vibration module 300 is positioned at the first position, sonic vibration having a first property corresponding to the first position may be output. Here, properties of sonic vibration may include at least one of a frequency, an amplitude, a vibration duration time, a waveform, and an intensity of the sonic vibration. For example, when the sonic vibration module 300 is positioned near a shoulder of a user, sonic vibration corresponding to a corresponding position may be output.

The sonic vibration module 300 may output sonic vibration in which the properties of sonic vibration are adjusted. For example, the sonic vibration module 300 may receive the same sound source and may change the properties of sonic vibration to output the sonic vibration having the first property. For another example, the sonic vibration module 300 may receive a sound source corresponding to a corresponding position to output sonic vibration.

The human body stimulation device 1 may identify the second position of the sonic vibration module 300 (S2200).

Here, the second position may be a position different from the first position and may refer to a position to which the sonic vibration module 300 is moved from the first position by the driving unit 100 or a position at which another sonic vibration module 300 is installed.

For example, the position detection unit 500 may know a position of the sonic vibration module 300 through an encoder, a magnetic sensor, an optical sensor, a pressure sensor, or the like provided in a preset area of an arm 200 or the human body stimulation unit 10. For another example, the controller 600 may identify the second position of the sonic vibration module 300 from the memory (not shown) in which the position information of the massage applicator installed at the preset position is stored. Here, the sonic vibration module 300 may be provided in a form in which the plurality of sonic vibration modules 300 are fixedly installed in the human body stimulation device 1 and positioned at different positions.

The human body stimulation device 1 may provide the second vibration massage corresponding to the second position of the sonic vibration module 300 (S2300).

When the sonic vibration module 300 is positioned at the second position, sonic vibration having a second property corresponding to the second position may be output. Here, the second property of the sonic vibration may be different from the first property corresponding to the first position. The above-described contents may be applied to operation S2300, and thus detailed contents will be omitted.

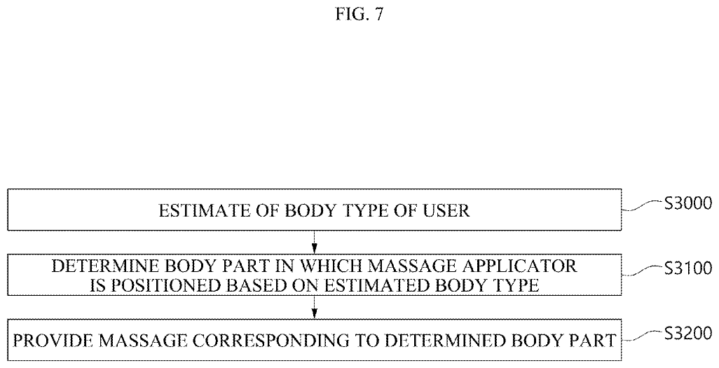

FIG. 7 is a flowchart of a method of providing a massage according to another embodiment. Referring to FIG. 7, the method of providing a massage according to another embodiment may include estimating a body type of a user (S3000), determining a body part at which a massage applicator is positioned based on the estimated body type (S3100), and providing a massage corresponding to the determined body part (S3200).

A human body stimulation device 1 may estimate the body type of the user (S3000).

A controller 600 may detect a portion of a body of the user through a position detection unit 500 and may estimate the body type of the user based on a position of the detected portion of the body. For example, the controller 600 may detect a shoulder of the user through the position detection unit 500 and may estimate a body length of the user using a position of the detected shoulder. For another example, the controller 600 may detect left and right ends of the user through the position detection unit 500 and may estimate a body width of the user using positions of the detected ends.

The controller 600 may acquire body information of the user (for example, weight, height, or body mass index (BMI) information of the user) from an operation unit (not shown) and may also estimate the body type of the user based on the acquired body information.

The controller 600 may estimate the body type of the user through a sensor provided in the human body stimulation device 1. For example, the controller 600 may detect pressure applied by the user using a pressure sensor and may estimate the body type of the user using the detected pressure. As an example, the controller 600 may estimate a muscle mass, a fat mass, or the like of the user based on the pressure detected by the pressure sensor. This is because the pressure detected by the pressure sensor varies according to a bone, fat, or a muscle mass.

The human body stimulation device 1 may determine the body part at which the massage applicator is positioned based on the estimated body type of the user (S3100).

For example, the controller 600 may identify a position of the massage applicator through the position detection unit 500 and may determine at which body part the massage applicator is positioned based on the estimated body type of the body part. Accordingly, the human body stimulation device 1 may more accurately determine a body part in consideration of body characteristics for each user.

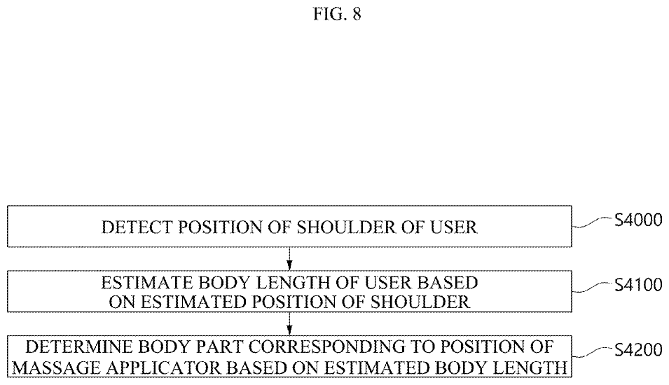

A method of determining a body part based on a body type of a user will be described with reference to FIGS. 8 to 10.

FIG. 8 is a flowchart of a method of determining a body part according to one embodiment.

Referring to FIG. 8, the method of determining a body part according to one embodiment may include detecting a position of a shoulder of a user (S4000), estimating a body length of the user using the detected position of the shoulder (S4100), and determining a body part corresponding to a position of a massage applicator based on the estimated body length (S4200).

A human body stimulation device 1 may detect the position of the shoulder of the user (S4000).

A controller 600 may detect the shoulder of the user through a position detection unit 500 to estimate a body type of the user. For example, the controller 600 may vertically move a human body stimulation unit 10 along a backrest 20 and may detect the shoulder of the user based on a load change according to upper and lower positions of an applicator (for example, a massage ball 400 or a sonic vibration module 300). Here, when the applicator moves upward beyond the shoulder of the user, since a load detected by a position detection sensor decreases, upper and lower positions of the shoulder may be known. Since a magnitude of a load is also related to front and rear positions of the applicator, when the position of the shoulder is detected, the front and rear positions of the applicator detected from the position detection sensor may also be considered.

The human body stimulation device 1 may estimate the body length of the user using the detected position of the shoulder (S4100).

The controller 600 may estimate the body length of the user based on a length between the detected position of the shoulder and a preset position. For example, the controller 600 may estimate the length between the detected position of the shoulder and a position near a hip as a length of an upper body of the user. Here, the position near the hip may be detected by a separate position detection sensor, and the body length of the user may be estimated in other ways in which the body length of the user is estimated using a position near a foot rather than the position near the hip.

The human body stimulation device 1 may determine the body part corresponding to the position of the massage applicator based on the estimated body length (S4200).

According to one embodiment, the controller t600 may divide the estimated body length into a plurality of sections each having a preset proportion and may determine a body part corresponding to each section. That is, the controller 600 may determine a body part based on a vertical position. Here, the preset proportion may be set based on a standard proportion for each body part of a person. For example, the human body stimulation device 1 may divide a body length into three sections according to the standard proportion for each body part and may make the sections correspond to a shoulder, a waist, and a hip.

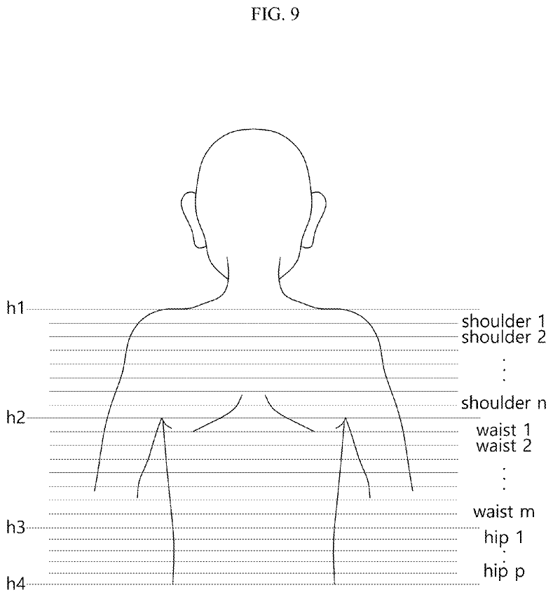

FIG. 9 is a diagram related to determination of a body part according to one embodiment. Referring to FIG. 9, for example, a controller 600 may divide an estimated length from a line h1 to a line h4 of an upper body into three sections (section from the line h1 to a line h2, section from the line h2 to a line h3, and section from the line h3 to the line h4) each having a preset proportion and may determine section from the line h1 to the line h2, the section from the line h2 to the line h3, and the section from the line h3 to the line h4 as a shoulder part, a waist part, and a hip part, respectively. In addition, each part may be further subdivided for a better massage feeling. As an example, the shoulder part may be subdivided into shoulder 1 and shoulder 2 to shoulder n, the waist part may be subdivided into waist 1 and waist 2 to waist m, and the hip part may be subdivided into hip 1 to hip p. Here, m, n, and o may be positive integers.

According to one embodiment, the controller 600 may divide an estimated body width into a plurality of sections each having a preset proportion and may determine a body part corresponding to each section. That is, the controller 600 may determine a body part based on left and right positions. Here, the preset proportion may be set based on a standard proportion for each body part of a person. For example, a human body stimulation device 1 may divide a body width into three sections according to the standard proportion for each body part and may make the sections correspond to an inner part, a middle part, and an outer part.

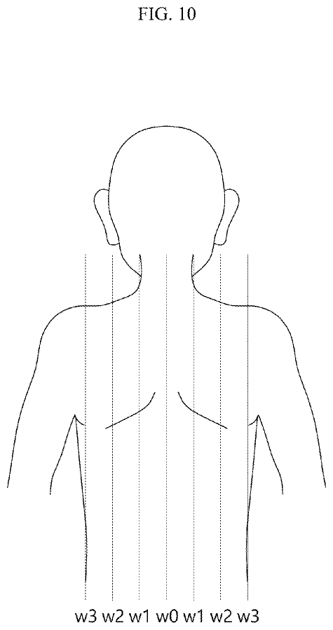

FIG. 10 is a diagram related to determination of a body part according to another embodiment. Referring to FIG. 10, for example, a controller 600 may divide an estimated width from a line w0 to a line w3 of an upper body into three sections (section from the line w0 to a line w1, section from the line w1 to a line w2, and section from the line w2 to the line w3) which each have a preset proportion and are each provided as two sections having bilateral symmetry and may determine the section from the line w0 to the line w1, the section from the line w1 to the line w2, and the section from the line w2 to the line w3 as an inner part, a middle part, and an outer part, respectively.

Of course, the determination of the body part is not limited to FIGS. 9 and 10. The body part may be subdivided to include a neck part, a back part, and the like, or the determination of the body part may be implemented in other ways in which the body part may be determined through a method in which the contents shown in FIGS. 9 and 10 are combined.

Returning to FIG. 7 again, descriptions will be provided.

The human body stimulation device 1 may provide the massage corresponding to the determined body part (S3200).

The controller 600 may provide a massage through a body stimulation unit 10 for each body part based on the determined body part. For example, the controller 600 may provide a first massage to a first body part through the human body stimulation unit 10 and may provide a second massage different from the first massage to a second body part different from the first body part through the human body stimulation unit 10. Here, in a massage provided for each body part, types, intensities, and properties of massages, combinations thereof, and the like may be different. As an example, the human body stimulation device 1 may provide a sonic vibration massage or a motion massage according to a body part, and intensities or characteristics of the provided massages may be different.

According to one embodiment, the human body stimulation device 1 may provide a vibration massage corresponding to a body part.

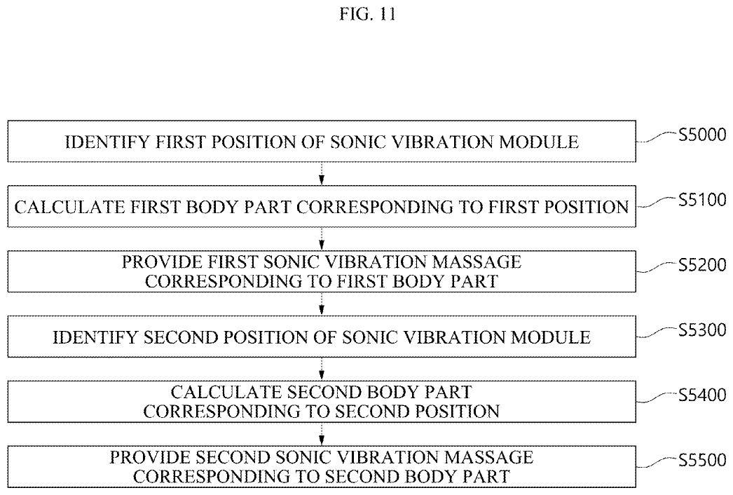

FIG. 11 is a flowchart of a method of providing a vibration massage for each body part according to one embodiment.

Referring to FIG. 11, the method of providing a vibration massage for each body part according to one embodiment may include identifying a first position of a sonic vibration module 300 (S5000), calculating a first body part corresponding to the first position (S5100), providing a first sonic vibration massage corresponding to the first body part (S5200), identifying a second position of the sonic vibration module 300 (S5300), calculating a second body part corresponding to the second position (S5400), and providing a second sonic vibration massage corresponding to the second body part (S5500).

A human body stimulation device 1 may identify the first position of the sonic vibration module 300 (S5000).

The above-described contents may be applied to the identification of the first position of the sonic vibration module 300 without any change, and thus more detailed contents will be omitted.

The human body stimulation device 1 may calculate the first body part corresponding to the first position (S5100).

A controller 600 may determine which body part is the first position at which the sonic vibration module 300 is positioned in consideration of an estimated body type of a user.

Referring to FIG. 9, for example, the controller 600 may determine a body part according to a position of the sonic vibration module 300 in consideration of an estimated body length from a line h1 to a line h4 of the user. Here, the controller 600 may determine a body part as a shoulder part when the sonic vibration module 300 is positioned within a section from the line h1 to a line h2, may determine a body part as a waist part when the sonic vibration module 300 is positioned within a section from the line 2 to a line h3, and may determine a body part as a hip part when the sonic vibration module 300 is positioned within a section from the line h3 to the line h4.

Referring to FIG. 10, for example, the controller 600 may determine a body part according to the position of the sonic vibration module 300 in consideration of an estimated body width from a line w0 to a line w3 of the user. Here, the controller 600 may determine a body part as an inner part when the sonic vibration module 300 is positioned within a section from the line w0 to a line w1, may determine a body part as a middle part when the sonic vibration module 300 is positioned within a section from the line w1 to a line w2, and may determine a body part as an outer part when the sonic vibration module 300 is positioned within a section from the line w2 to the line w3.

The human body stimulation device 1 may provide the first sonic vibration massage corresponding to the first body part (S5200).

The sonic vibration module 300 may output sonic vibration that is optimal for the first body part in which the sonic vibration module 300 is positioned. Specifically, the sonic vibration module 300 may output low intensity sonic vibration to a body part requiring a low intensity vibration massage and may output high intensity sonic vibration to a body part requiring a high intensity vibration massage. For example, the sonic vibration module 300 may output sonic vibration that is optimal for the shoulder part. This is because, since body parts have different characteristics, it is necessary to provide different sonic vibration massages for each body part.

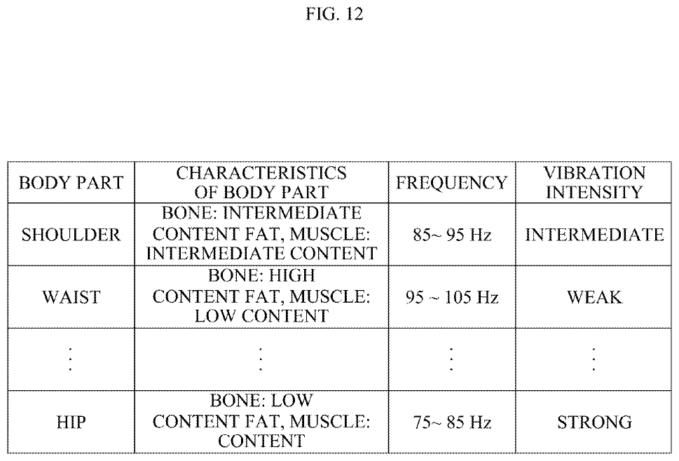

A relationship between a body part and a sonic vibration massage will be described with reference to FIG. 12.

FIG. 12 is a diagram illustrating an example of optimal vibration for each body part according to one embodiment. Referring to FIG. 12, examples of properties of vibration, for which a person generally feels comfortable and comfortable, are illustrated for each body part. The sonic vibration massage provided to a body part may be provided in consideration of the characteristics of the body part. Here, the sonic vibration module 300 may output sonic vibration having a frequency of 50 Hz to 150 Hz to each body part.

The properties of the sonic vibration output from the sonic vibration module 300 may vary according to the characteristics of a body part.

For example, in the sonic vibration output from the sonic vibration module 300, a frequency, an amplitude, a volume, a vibration duration time, and a waveform of a sound source used for vibration output may be provided differently according to the characteristics of a body part. The characteristics of the body part may be related to a content of at least one of a bone, a fat, and a muscle. As an example, the first body part, which has a bone content that is higher than that of the second body part, may require sonic vibration having a low intensity as compared with the second body part. As another example, the first body part, which has a fat/muscle content that is higher than that of the second body part, may require sonic vibration having a high intensity as compared with the second body part.

For example, the human body stimulation unit 10 may output high frequency sonic vibration to the first body part having has a bone content that is higher than that of the second body part and may output low frequency sonic vibration to the second body part.

For example, the human body stimulation unit 10 may output high frequency sonic vibration to the first body part having a fat/muscle content that is lower than that of the second body part and may output low frequency sonic vibration to the second body part.

For example, the human body stimulation unit 10 may output low amplitude sonic vibration to the first body part having a bone content that is higher than that of the second body part and may output high amplitude sonic vibration to the second body part.

For example, the human body stimulation unit 10 may output low amplitude sonic vibration to the first body part having a fat/muscle content that is lower than that of the second body part and may output high amplitude sonic vibration to the second body part.

For example, the human body stimulation unit 10 may output sonic vibration with a gradually changing waveform to the first body part having a bone content that is higher than that of the second body part and may output sonic vibration with a rapidly changing waveform to the second body part.

For example, the human body stimulation unit 10 may output sonic vibration with a gradually changing waveform to the first body part having a fat/muscle content that is lower than that of the second body part and may output sonic vibration with a rapidly changing waveform to the second body part.

Generally, since a shoulder part has a relatively intermediate content of a bone and a relatively intermediate content of a fat and muscle, a sonic vibration massage having an intermediate intensity may be provided. For example, vibration having a frequency in a range of 85 Hz to 95 Hz may be applied to the shoulder part such that a user feels comfortable and comfortable. Here, a relative vibration intensity may be applied as an intermediate intensity.

Generally, since a waist part has a relatively high content of a bone and a relatively high content of a fat and muscle, a sonic vibration massage having a weak intensity may be provided. For example, vibration having a frequency in a range of 95 Hz to 105 Hz may be applied to the waist part such that the user feels comfortable and comfortable. Here, a relative vibration intensity may be applied as a weak intensity.

Generally, since a hip part has a relatively low content of a bone and a relatively high content of a fat and muscle, a sonic vibration massage having a strong intensity may be provided. For example, vibration having a frequency in a range of 75 Hz to 85 Hz may be applied to the hip part such that the user feels comfortable and comfortable. Here, a relative vibration intensity may be applied as a strong intensity.

However, a vibration massage optimal for each body part is not limited to the above description, and the vibration massage optimal for each body part may be implemented in other ways in which a vibration massage in which a vibration massage time and a waveform or the like of a sound source used for vibration output are optimally adjusted according to a body part is provided for each body part.

The human body stimulation device 1 may identify the second position of the sonic vibration module 300 (S5300).

Here, the second position may be a different position from the first position. The above-described contents may be applied to the identification of the second position of the sonic vibration module 300 without any change, and thus more detailed contents will be omitted.

The human body stimulation device 1 may calculate the second body part corresponding to the second position (S5400).

Here, the second body part may be a different body part from the first body part. The above-described contents may be applied to the calculation of the second body part without any change, and thus more detailed descriptions will be omitted.

The human body stimulation device 1 may provide the second sonic vibration massage corresponding to the second body part (S5500).

The sonic vibration module 300 may output sonic vibration that is optimal for the second body part different from the first body part. Here, the second sonic vibration massage may be a massage that outputs sonic vibration having a different property from the first sonic vibration massage. For example, the second sonic vibration massage may be different from the first sonic vibration massage in frequency, vibration intensity, massage time, and waveform of an input sound source.

The above-described contents may be applied to the provision of the second sonic vibration corresponding to the second body part without any change, and thus more detailed descriptions will be omitted.

However, the method of providing a vibration massage for each body part is not limited to the above description and may be implemented in other ways. For example, the human body stimulation device 1 may detect characteristics of a body part for each body part through a separate sensor and may provide a vibration massage according to the detected characteristics of the body part. In this case, it is possible to solve a problem caused by slightly different characteristics of body parts for each user.

According to one embodiment, the human body stimulation device 1 may provide a massage in consideration of an acupoint. For example, when human body stimulation device 1 provides a sonic vibration massage to a body part having an acupoint, the human body stimulation device 1 may provide the sonic vibration massage in consideration of the acupoint.

Here, the acupoint may be a well-known concept in Korean medicine and may refer to a narrow part (point) of a body on which acupuncture or moxibustion is to be applied to treat a disease or to improve body health. The acupoint may be understood as meaning a pain point as a medical concept. For example, the acupoint may include acupoints of “an myun,” “pung bu,” “cheon ju,” “pung ji,” “gyeon jeong,” “gyeon Jung su,” “gyeon oe su,” “ji su,” “sim su,” “yeong dae,” “dok su,” “ui hoe,” “gyeok su,” “gyeok gwan,” “ji yang,” “hon mun,” “gan su,” “dam su,” “yang gang,” “bi su,” “ui sa,” “wi su,” “wi chang,” “sam cho su,” “sim su,” “ji sil,” “myeong mun,” “gi hae su,” “dae jang su,” “gwan won su”, “so jang su,” “bang gwang su,” “sang nyo,” “mi gol dan,” and “cha ryo.”

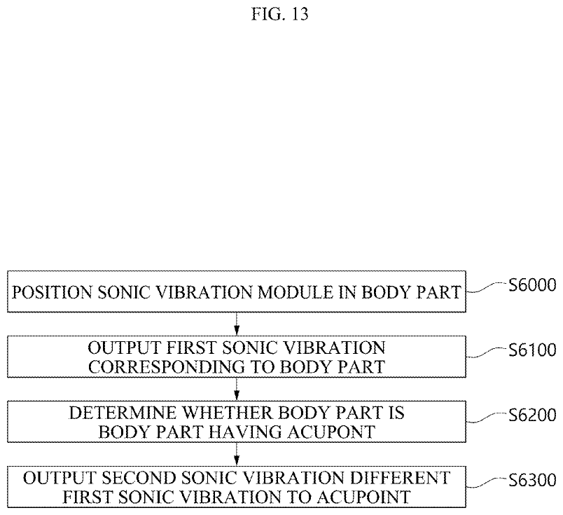

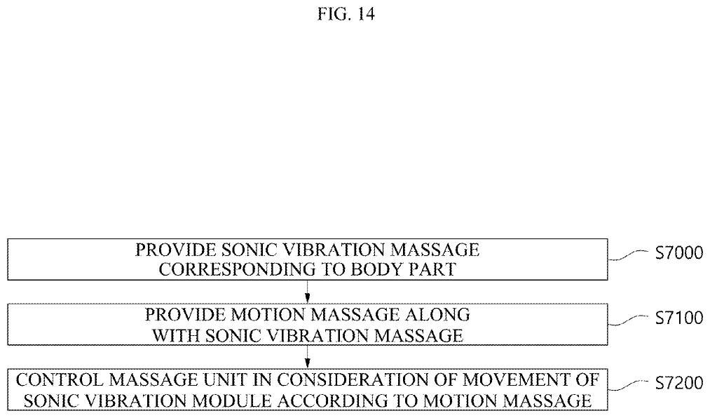

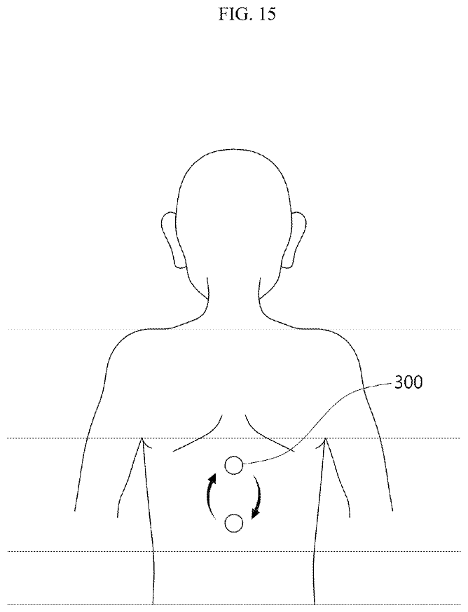

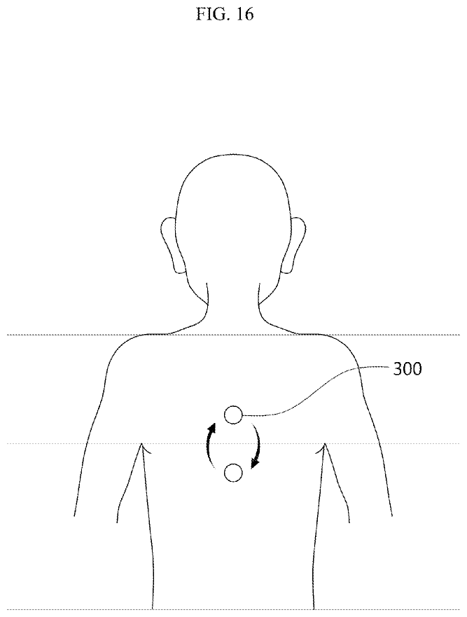

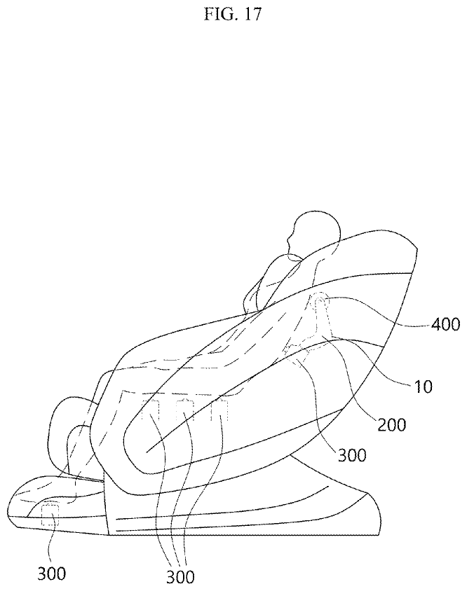

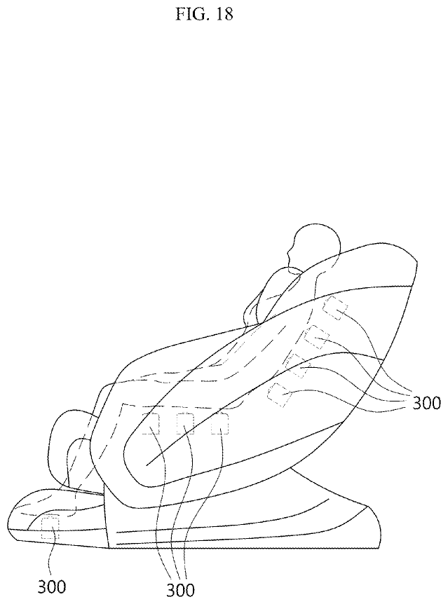

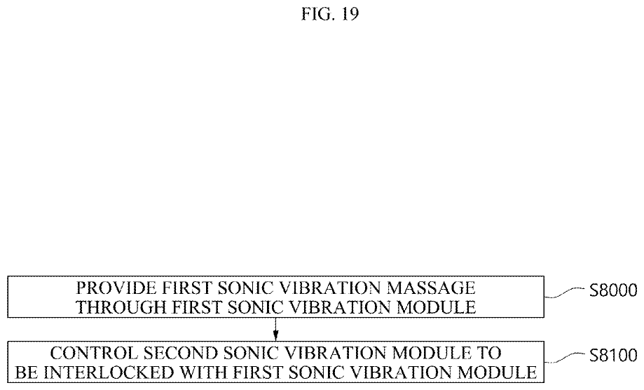

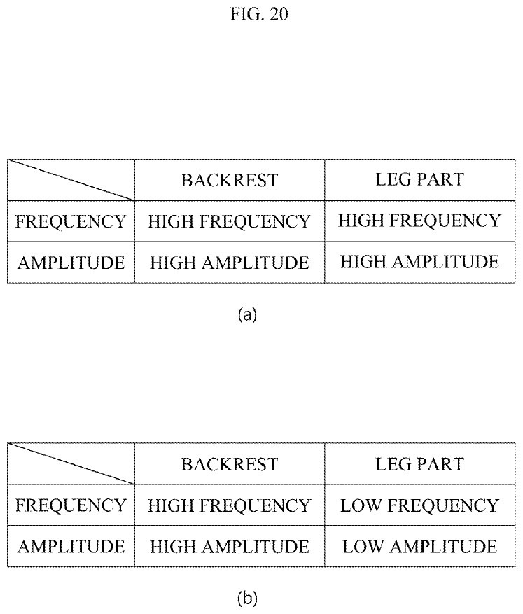

FIG. 13 is a flowchart of a method of providing a vibration massage in consideration of an acupoint according to one embodiment. Referring to FIG. 13, the method of providing a vibration massage in consideration of an acupoint according to one embodiment may include positioning a sonic vibration module 300 in a body part (S6000), outputting first sonic vibration corresponding to the body part (S6100), and outputting second sonic vibration different from the first sonic vibration to an acupoint (S6200).

A human body stimulation device 1 may position the sonic vibration module 300 in the body part (S6000).

The above-described contents may be applied to operation S6000 without any change, and thus more different from the descriptions, and/or the elements, such as a system, a structure, a device, a circuit, and so on, are combined or assembled in other ways different from the descriptions, or replaced or substituted with other elements or their equivalents.

What is claimed is:

1. A human body stimulation device for providing a sonic vibration massage in response to a body part of a user, the human body stimulation device comprising:
a human body stimulation unit including a sonic vibration module configured to apply sonic vibration to a body of the user;
a driving unit including at least one motor configured to move the sonic vibration module;
a position detection unit configured to detect a position of the sonic vibration module; and
a controller,
wherein:
the controller determines a body part corresponding to the detected position of the sonic vibration module and controls the sonic vibration module to output the sonic vibration based on characteristics of the body part;
when the sonic vibration module is positioned at a first body part requiring the sonic vibration massage through sonic vibration having a first property, the sonic vibration module outputs the sonic vibration having the first property;
when the sonic vibration module is positioned at a second body part requiring the sonic vibration massage through sonic vibration having a second property that is different from the first property, the sonic vibration module outputs the sonic vibration having the second property; and
the first property and the second property of the sonic vibration include at least one of a frequency, an amplitude, and a waveform of the sonic vibration.

2. The human body stimulation device of claim 1, wherein the characteristics of the body part are related to a content of at least one of a bone, a fat, and a muscle.

3. The human body stimulation device of claim 2, wherein:
the first body part has the content of the bone that is higher than that of the second body part;
the sonic vibration having the first property is sonic vibration having a high frequency; and
the sonic vibration having the second property is sonic vibration having a low frequency.

4. The human body stimulation device of claim 2, wherein:
the first body part has the content of the fat and/or muscle that is lower than that of the second body part;
the sonic vibration having the first property is sonic vibration having a high frequency; and
the sonic vibration having the second property is sonic vibration having a low frequency.

5. The human body stimulation device of claim 2, wherein:
the first body part has the content of the bone that is higher than that of the second body part;
the sonic vibration having the first property is sonic vibration having a low amplitude; and
the sonic vibration having the second property is sonic vibration having a high amplitude.

6. The human body stimulation device of claim 2, wherein:
the first body part has the content of the fat and/or muscle that is lower than that of the second body part;
the sonic vibration having the first property is sonic vibration having a low amplitude; and
the sonic vibration having the second property is sonic vibration having a high amplitude.

7. The human body stimulation device of claim 1, wherein:
the human body stimulation unit provides a motion massage including a tapping massage and/or a kneading massage along with the sonic vibration massage to the body part; and
the human body stimulation unit provides the sonic vibration massage in consideration of movement of the sonic vibration module according to the motion massage.

8. The human body stimulation device of claim 7, wherein:
the human body stimulation unit provides the motion massage such that the sonic vibration module moves only within the first body part or the second body part; and
the sonic vibration module outputs sonic vibration having a property corresponding to the body part to which the motion massage is provided.

9. The human body stimulation device of claim 7, wherein:
the human body stimulation unit provides the motion massage such that the sonic vibration module moves between the first body part and the second body part; and
the sonic vibration module outputs the sonic vibration having the first property when the sonic vibration module is positioned at the first body part due to the motion massage and outputs the sonic vibration having the second property when the sonic vibration module is positioned at the second body part due to the motion massage.

10. The human body stimulation device of claim 7, wherein:
the human body stimulation unit provides the motion massage such that the sonic vibration module moves between the first body part and the second body part; and
the sonic vibration module outputs sonic vibration having a third property representing the first property and the second property.

11. The human body stimulation device of claim 1, further comprising a massage ball that moves in conjunction with the sonic vibration module,
wherein the human body stimulation unit provides a motion massage including a tapping massage and/or a kneading massage in consideration of a position of the massage ball.

12. The human body stimulation device of claim 1, wherein:
the body part has an acupoint; and
the sonic vibration module outputs sonic vibration, having a different property from the sonic vibration output to the body part, at a position corresponding to the acupoint.

13. The human body stimulation device of claim 1, wherein the position detection unit includes at least one sensor configured to detect at least one of a vertical position and a horizontal position of the human body stimulation unit.

14. The human body stimulation device of claim 1, further comprising an additional human body stimulation unit which is disposed at a different position from the human body stimulation unit and includes an additional sonic vibration module,
wherein the controller controls the sonic vibration module in conjunction with the additional sonic vibration module.

15. The human body stimulation device of claim 14, wherein the controller controls at least one of a vibration start time, a vibration duration time, a frequency, an amplitude, and a waveform of sonic vibration output from the sonic vibration module to be synchronized with at least one of a vibration start time, a vibration duration time, a frequency, an amplitude, and a waveform of sonic vibration output from the additional sonic vibration module.

16. The human body stimulation device of claim 1, comprising a human body stimulation device in a chair type, a sofa type, or a bed type.

17. A human body stimulation method of providing a sonic vibration massage in response to a body part of a user, the human body stimulation method comprising:
detecting a position of a human body stimulation unit including a sonic vibration module;
determining a body part corresponding to the detected position of the human body stimulation unit; and
controlling the sonic vibration module to output sonic vibration based on characteristics of the body part,
wherein:
when the sonic vibration module is positioned at a first body part requiring the sonic vibration massage through sonic vibration having a first property, the sonic vibration module outputs the sonic vibration having the first property;
when the sonic vibration module is positioned at a second body part requiring the sonic vibration massage through sonic vibration having a second property that is different from the first property, the sonic vibration module outputs the sonic vibration having the second property; and
the first property and the second property of the sonic vibration include at least one of a frequency, an amplitude, and a waveform of the sonic vibration.
